(19) United States
(12) Patent Application Publication
(10) Pub. No.: US 2022/0405723 A1
(43) Pub. Date: Dec. 22, 2022

(54) Conducting Secure Fragmented Payment Transactions

(71) Applicant: Bank of America Corporation, Charlotte, NC (US)

(72) Inventors: Sindhuja Gunda, Hyderabad (IN); Udaya Kumar Raju Ratnakaram, Hyderabad (IN)

(21) Appl. No.: 17/349,458

(22) Filed: Jun. 16, 2021

(51) Int. Cl. G06Q 20/10; G06N 20/00; G06Q 20/22; G06Q 20/40; G06Q 20/02; G06Q 40/02

(52) U.S. Cl. CPC G06Q 20/102; G06N 20/00; G06Q 20/227; G06Q 20/401; G06Q 20/02; G06Q 40/02

(57) ABSTRACT

Aspects of the disclosure relate to fragmenting payment transactions. A computing platform may receive, from a computing device, a request for a payment transaction. The computing platform may retrieve user identifying information associated with fragmenting payment transactions. Based on the user identifying information, the computing platform may determine whether to fragment the payment transaction between a plurality of user accounts. Based on determining to fragment the payment transaction, the computing platform may generate, using a machine learning algorithm, allocation information indicating an amount of funds to be transferred from each of the plurality of user accounts. The computing platform may cause the computing device to prompt a user of the computing device to confirm the allocation information. The computing platform may transfer funds to a recipient account in accordance with the allocation information and send a notification indicating completed processing of the fragmented payment transaction.

### BACKGROUND

Aspects of the disclosure generally relate to one or more computer systems, servers, and/or other devices including hardware and/or software. In particular, one or more aspects of the disclosure relate to fragmenting payment transactions.

Typically, in a payment transaction, users are given the option to choose a single payment account for processing a payment. In some instances, such as for large transactions, the user might require funds from more than one account to cover the payment. In order to accumulate sufficient funds in one account, a user may manually transfer funds between accounts at one or more financial institutions. Such a process may be cumbersome and time-consuming. In some instances, the user may wish to take advantage of different incentives or benefits offered for using various cards. It may be difficult to use traditional tools to provide frictionless transactions involving multiple payment cards or accounts.

### SUMMARY

Aspects of the disclosure provide effective, efficient, scalable, and convenient technical solutions that address and overcome the technical problems associated with fragmenting payment transactions. In particular, one or more aspects of the disclosure provide a platform that allows users the flexibility to use multiple cards or accounts for a purchase or payment transaction. In addition, users may enter a stipulated amount to be deducted from each account or card (e.g., based on funds availability). Additional aspects of the disclosure may, from a user standpoint, treat the payment transaction as a single transaction, while in the backend processing, the payment transaction may be segregated into multiple individual transactions involving different authentication mechanisms. Additional aspects of the disclosure may provide fragmented transaction initiation through voice activated devices.

In accordance with one or more embodiments, a computing platform having at least one processor, a communication interface, and memory may receive a request for a payment transaction from a computing device. The computing platform may retrieve user identifying information associated with fragmenting payment transactions. Based on the user identifying information, the computing platform may determine whether to fragment the payment transaction between a plurality of user accounts. Based on determining to fragment the payment transaction, the computing platform may generate, using a machine learning algorithm, allocation information indicating an amount of funds to be transferred from each of the plurality of user accounts. In some examples, the computing platform may cause the computing device to prompt a user of the computing device to confirm the allocation information. The computing platform may transfer funds to a recipient account in accordance with the allocation information. The computing platform may send a notification indicating completed processing of the fragmented payment transaction.

In some embodiments, the computing platform may, prior to transferring funds to the recipient account in accordance with the allocation information, receive, from the user of the computing device, input specifying one or more modifications to the allocation information; and modify the allocation information indicating the amount of funds to be transferred from each of the plurality of user accounts.

In some arrangements, retrieving user identifying information associated with fragmenting payment transactions may include retrieving one or more pre-established user preferences associated with fragmenting payment transactions. In some examples, the one or more pre-established user preferences are defined by the user.

In some embodiments, retrieving user identifying information associated with fragmenting payment transactions may include retrieving account information associated with a plurality of financial accounts of a user. In some examples, retrieving the account information associated with the plurality of financial accounts of the user may include retrieving account information associated with one or more of: a credit card account, a checking account, a savings account, a debit card account, or a stored value account. In some examples, retrieving the account information associated with the plurality of financial accounts of the user may include retrieving an account balance or a credit limit for each of the plurality of financial accounts.

In some example arrangements, generating the allocation information may include generating the allocation information indicating an amount of funds to be transferred from each of the plurality of user accounts based on historical allocation information.

In some embodiments, receiving the request for the payment transaction may include receiving, from a merchant system, the request initiated on a mobile device executing an application associated with a merchant.

In some embodiments, fragmenting the payment transaction between the plurality of user accounts may include authenticating with third-party accounts of the plurality of user accounts using a single one-time password (OTP) token.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for fragmenting payment transactions in accordance with one or more example embodiments;

FIGS. 2A-2D depict an illustrative event sequence for fragmenting payment transactions in accordance with one or more example embodiments;

FIGS. 3A-3E depict another illustrative event sequence for fragmenting payment transactions in accordance with one or more example embodiments;

FIGS. 4 and 5 illustrative graphical user interfaces associated with fragmenting payment transactions in accordance with one or more example embodiments; and

FIGS. 6 and 7 depict illustrative methods for fragmenting payment transactions in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

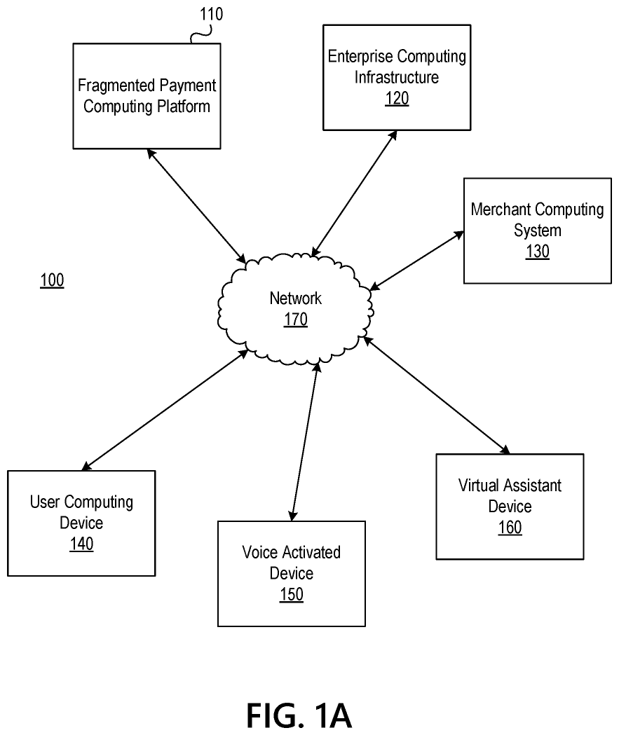

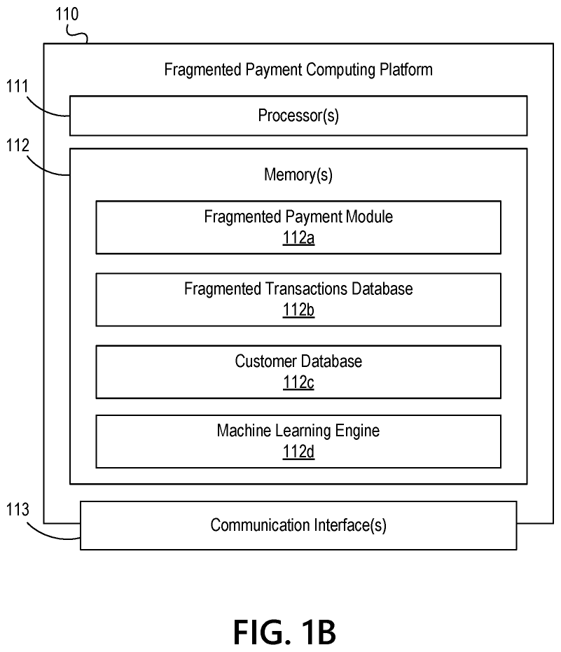

FIGS. 1A and 1B depict an illustrative computing environment for fragmenting payment transactions in accordance with one or more example embodiments. Referring to FIG. 1A, computing environment 100 may include one or more computing devices and/or other computing systems. For example, computing environment 100 may include fragmented payment computing platform 110, enterprise computing infrastructure 120, merchant computing system 130, user computing device 140, voice activated device 150, and virtual assistant device 160. Although one user computing device 140 is shown for illustrative purposes, any number of user computing devices may be used without departing from the disclosure. In addition, although one voice activated device 150 is shown for illustrative purposes, any number of voice activated devices may be used without departing from the disclosure.

As illustrated in greater detail below, fragmented payment computing platform 110 may include one or more computing devices configured to perform one or more of the functions described herein. For example, fragmented payment computing platform 110 may include one or more computers (e.g., laptop computers, desktop computers, servers, server blades, or the like).

In one or more arrangements, fragmented payment computing platform 110 may be associated with an enterprise organization, such as a financial institution, and fragmented payment computing platform 110 may be connected to other servers and/or enterprise computing infrastructure 120 that is configured to provide various enterprise and/or back-office computing functions for the enterprise organization. For example, this enterprise computing infrastructure 120 may include various servers and/or databases that store and/or otherwise maintain account information, such as financial account information including account balances, transaction history, account owner information, and/or other information. In addition, enterprise computing infrastructure 120 may process and/or otherwise execute transactions on specific accounts based on commands and/or other information received from other computer systems included in computing environment 100.

Also, in the operating environment, is one or more merchant computing systems 130 that is network enabled. In the context of an online shopping experience, the merchant computing system 130 may be one or more financial transaction servers that, either individually or working in concert, are capable of providing web pages to a customer via the network 170, receiving purchase orders for items selected by the customer, communicating with the customer and third party financial institutions to secure payment for the order, and transmitting order confirmation, and possibly shipping confirmation information, to the customer via the network 170 regarding the purchase transaction. In the context of an in-store purchase, the merchant computing system 130 may include a point of sale terminal for scanning or receiving information about products or services being purchased by the customer and communicating with the customer and third party financial institutions to secure payment for the order. Either a point of sale device or a connected merchant server may be used to communicate order confirmation or purchase confirmation information to the customer related to the purchase transaction.

User computing device 140 may include one or more computing devices and/or other computer components (e.g., processors, memories, communication interfaces). For instance, user computing device 140 may be a server, desktop computer, laptop computer, tablet, mobile device, or the like, and may be used by a customer of an organization, such as a customer of a financial institution.

Voice activated device 150 may be and/or include a smart speaker or other voice command device or voice assistant. Voice activated device 150 may provide interactive actions by detecting spoken “hotwords” (e.g., predefined words or phrases for triggering the voice activated device).

Virtual assistant device 160 may be and/or include an artificial intelligence driven virtual financial assistant. Virtual assistant device 160 may be voice-controlled and use natural language and predictive analytics to assist users in conducting one or more financial transactions. Virtual assistant device 160 may learn from users' actions, request, and the like, over time.

Computing environment 100 also may include one or more networks, which may interconnect one or more of fragmented payment computing platform 110, enterprise computing infrastructure 120, merchant computing system 130, user computing device 140, voice activated device 150, and virtual assistant device 160. For example, computing environment 100 may include network 170. Network 170 may include one or more sub-networks (e.g., local area networks (LANs), wide area networks (WANs), or the like). For example, network 170 may include a private sub-network that may be associated with a particular organization (e.g., a corporation, financial institution, educational institution, governmental institution, or the like) and that may interconnect one or more computing devices associated with the organization. For example, fragmented payment computing platform 110, enterprise computing infrastructure 120, and virtual assistant device 160 may be associated with an organization (e.g., a financial institution), and network 170 may be associated with and/or operated by the organization, and may include one or more networks (e.g., LANs, WANs, virtual private networks (VPNs), or the like) that interconnect fragmented payment computing platform 110, enterprise computing infrastructure 120, and virtual assistant device 160. Network 170 also may include a public sub-network that may connect the private sub-network and/or one or more computing devices connected thereto (e.g., fragmented payment computing platform 110, enterprise computing infrastructure 120, and virtual assistant device 160) with one or more networks and/or computing devices that are not associated with the organization (e.g., merchant computing system 130, user computing device 140, and voice activated device 150).

In one or more arrangements, fragmented payment computing platform 110, enterprise computing infrastructure 120, merchant computing system 130, user computing device 140, voice activated device 150, and virtual assistant device 160 may be any type of computing device capable of receiving a user interface, receiving input via the user interface, and communicating the received input to one or more other computing devices. For example, fragmented payment computing platform 110, enterprise computing infrastructure 120, merchant computing system 130, user computing device 140, voice activated device 150, virtual assistant device 160, and/or the other systems included in computing environment 100 may, in some instances, include one or more processors, memories, communication interfaces, storage devices, and/or other components. As noted above, and as illustrated in greater detail below, any and/or all of the computing devices included in computing environment 100 may, in some instances, be special-purpose computing devices configured to perform specific functions.

Referring to FIG. 1B, fragmented payment computing platform 110 may include one or more processor(s) 111, memory(s) 112, and communication interface(s) 113. A data bus may interconnect processor 111, memory 112, and communication interface 113. Communication interface 113 may be a network interface configured to support communication between fragmented payment computing platform 110 and one or more networks (e.g., network 170 or the like). Memory 112 may include one or more program modules having instructions that when executed by processor 111 cause fragmented payment computing platform 110 to perform one or more functions described herein and/or one or more databases and/or other libraries that may store and/or otherwise maintain information which may be used by such program modules and/or processor 111.

In some instances, the one or more program modules and/or databases may be stored by and/or maintained in different memory units of fragmented payment computing platform 110 and/or by different computing devices that may form and/or otherwise make up fragmented payment computing platform 110. For example, memory 112 may have, store, and/or include a fragmented payment module 112a, a fragmented transactions database 112b, a customer database 112c, and a machine learning engine 112d. Fragmented payment module 112a may have instructions that direct and/or cause fragmented payment computing platform 110 to identify fragmented payment transactions (e.g., based on user preferences, account information, and/or machine learning), complete payments from multiple different accounts, allow reallocations of fragments, and/or perform other functions, as discussed in greater detail below. Fragmented transactions database 112b may store information (e.g., associating a transaction with a plurality of fragmented transactions) used by fragmented payment module 112a and/or fragmented payment computing platform 110 in conducting secure fragmented payment transactions and/or in performing other functions. Customer database 112c may store information (e.g., customer information, account or card information, and/or the like) used by fragmented payment module 112a and/or fragmented payment computing platform 110 in conducting secure fragmented payment transactions and/or in performing other functions. Machine learning engine 112d may have instructions that direct and/or cause fragmented payment computing platform 110 to set, define, and/or iteratively redefine rules, techniques and/or other parameters used by fragmented payment computing platform 110 and/or other systems in computing environment 100 in conducting secure fragmented payment transactions.

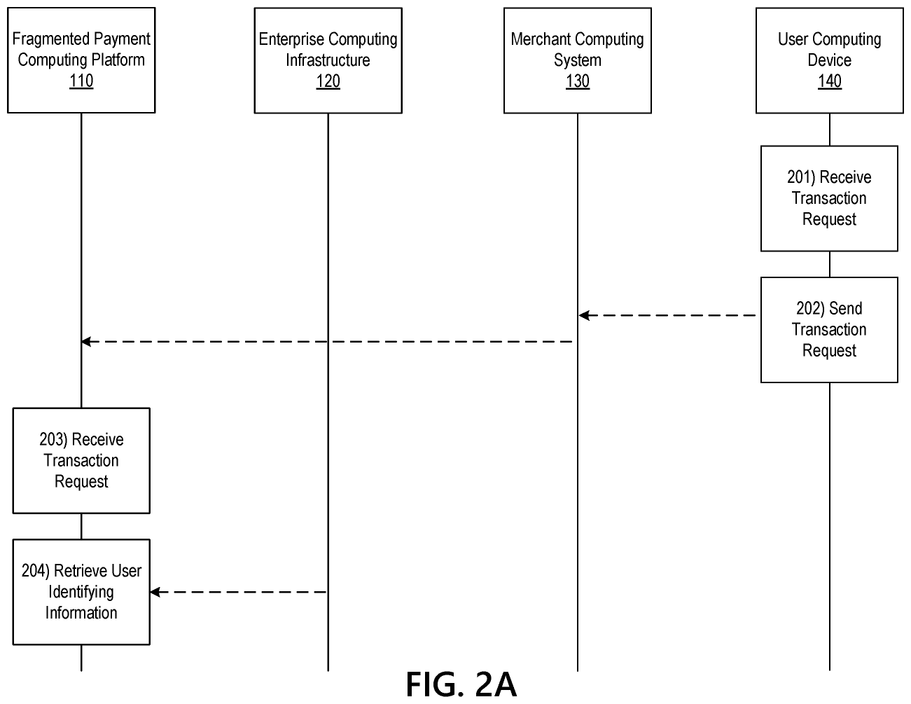

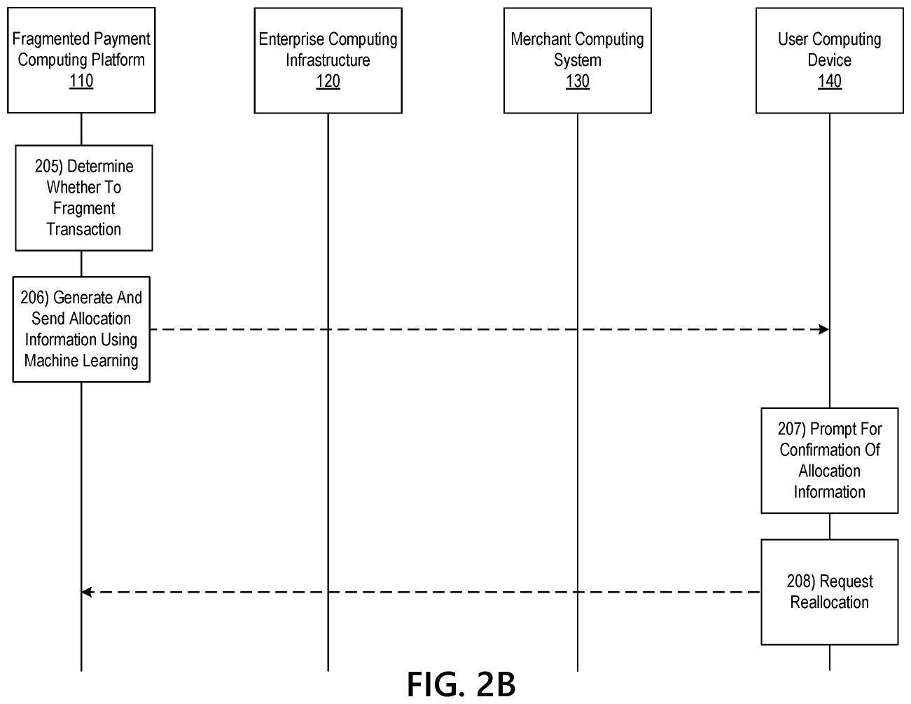

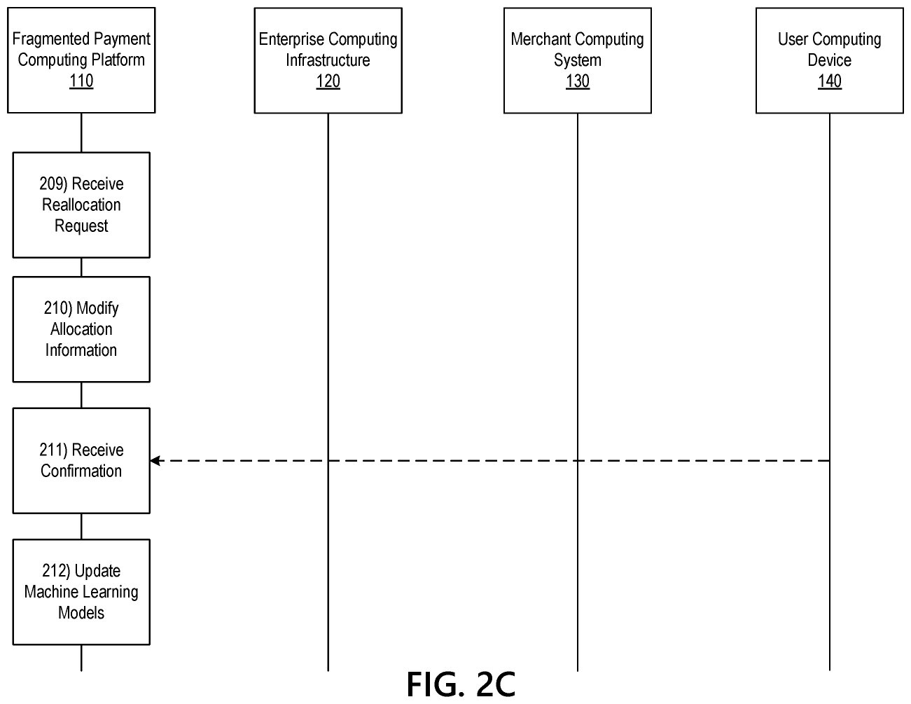

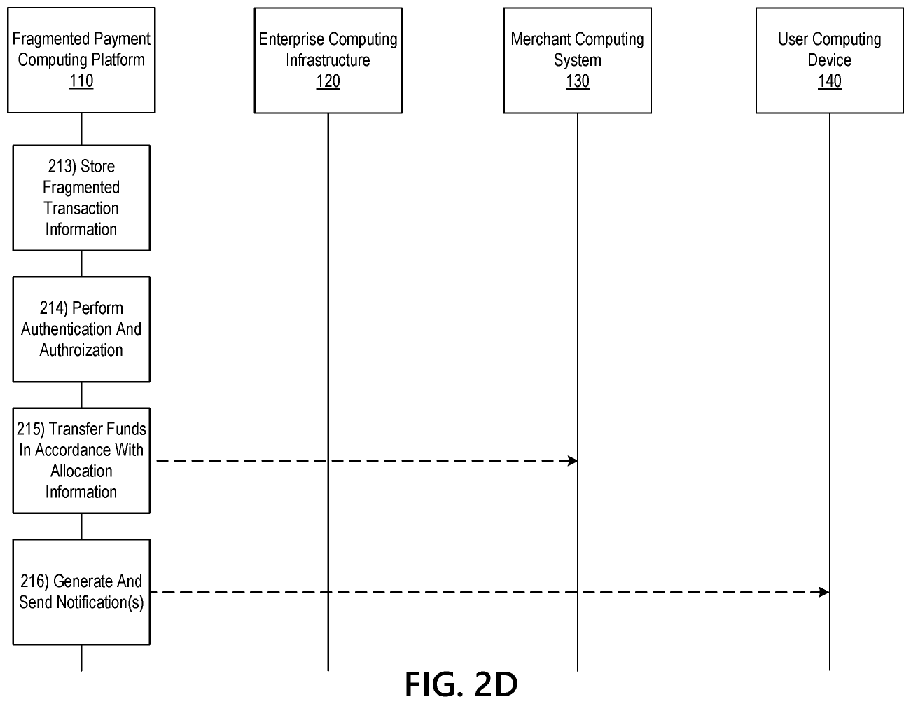

FIGS. 2A-2D depict an illustrative event sequence for fragmenting payment transactions in accordance with one or more example embodiments. For example, the example event sequence depicted in FIGS. 2A-2D illustrates a use case for fragmenting payment transactions involving transactions initiated through a user device (e.g., on a desktop computer via a website, or on a mobile device via a mobile application).

Referring to FIG. 2A, at step 201, a user of a computing device (e.g., user computing device 140) may initiate a transaction (e.g., a payment transaction) via a web or mobile interface. For example, the user of the computing device (e.g., user computing device 140) may place an online order with a merchant (e.g., add items to a virtual shopping cart) and pay for items at a checkout page of the merchant's website.

At step 202, the computing device (e.g., user computing device 140) may send the transaction request to fragmented payment computing platform 110 (e.g., via the merchant computing system 130). In turn, at step 203, fragmented payment computing platform 110 may receive, via the communication interface (e.g., communication interface 113), the request for the transaction (e.g., the payment transaction) initiated at the computing device (e.g., user computing device 140).

At step 204, fragmented payment computing platform 110 retrieve user identifying information associated with fragmenting payment transactions. In some examples, fragmented payment computing platform 110 may retrieve one or more pre-established user preferences associated with fragmenting payment transactions. Such pre-established user preferences may be defined by the user of the computing device (e.g., user computing device 140). For instance, a user may define a preference to use a particular account for high tendered amounts (e.g., above a threshold amount) and/or a preference to use a different particular account for low tendered amounts (e.g., below a threshold amount).

Additionally or alternatively, in retrieving user identifying information associated with fragmenting payment transactions at step 204, fragmented payment computing platform 110 may retrieve account information associated with a plurality of financial accounts of a user. For instance, fragmented payment computing platform 110 may retrieve account information associated with a credit card account, a checking account, a savings account, a debit card account, a stored value account, and/or the like, associated with the user of the computing device (e.g., user computing device 140). In addition, fragmented payment computing platform 110 may retrieve an account balance or a credit limit for each of the plurality of financial accounts of the user of the computing device (e.g., user computing device 140).

Referring to FIG. 2B, at step 205, fragmented payment computing platform 110 may determine whether to fragment (e.g., divide or split) the payment transaction between a plurality of user cards or accounts. The determination on whether to fragment the payment transaction may be made, for example, based on the user identifying information (e.g., retrieved at step 204). For instance, fragmented payment computing platform 110 may determine to fragment a transaction based on pre-established user preferences for fragmenting transactions and/or based a need or requirement to access funds associated with more than one account or card to process a transaction.

At step 206, based on determining to fragment the payment transaction, fragmented payment computing platform 110 may generate and send allocation information to the computing device (e.g., user computing device 140). For example, the allocation information may indicate an amount of funds to be transferred from each of the plurality of user accounts. In some examples, fragmented payment computing platform 110 may generate the allocation information indicating an amount of funds to be transferred from each of the plurality of user accounts based on historical allocation information (e.g., using machine learning or other artificial intelligence). For instance, fragmented payment computing platform 110 may, based on a transaction history of a user, suggest or prefill certain transaction details (e.g., allocation information) for the user, and the user may modify those details based on their needs, as discussed in greater detail below.

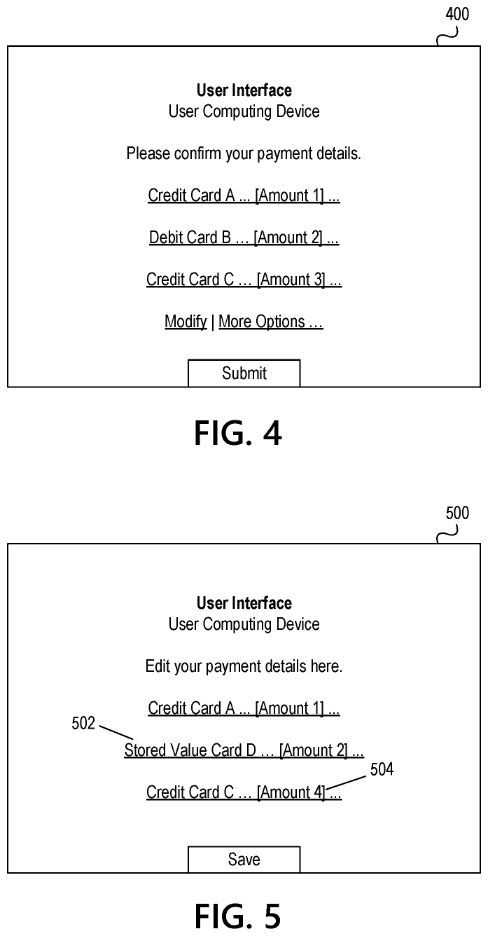

At step 207, fragmented payment computing platform 110 may cause the computing device (e.g., user computing device 140) to prompt the user of the computing device (e.g., user computing device 140) to confirm the allocation information (e.g., generated at step 206). For example, fragmented payment computing platform 110 may cause the computing device (e.g., user computing device 140) to display and/or otherwise present one or more graphical user interfaces similar to graphical user interface 400, which is illustrated in FIG. 4. As seen in FIG. 4, graphical user interface 400 may include text and/or other information notifying the user of the computing device (e.g., user computing device 140) of allocation information and providing an opportunity to perform reallocation (e.g., modify the allocation information) (e.g., “Please confirm your payment details. [Credit Card A . . . Amount 1 . . . ] [Debit Card B . . . Amount 2 . . . ] [Credit Card C . . . Amount 3 . . . ]”). It will be appreciated that other and/or different notifications may also be provided.

In some embodiments, returning to FIG. 2B, at step 208, prior to confirming the allocation information, the user of the computing device (e.g., user computing device 140) may send, via the communication interface (e.g., communication interface 113), a reallocation request (e.g., request to modify the allocation information).

Referring to FIG. 2C, at step 209, fragmented payment computing platform 110 may receive, via the communication interface (e.g., communication interface 113), from the user of the computing device (e.g., user computing device 140), input specifying one or more modifications to the allocation information. For example, prior to confirming the allocation information (e.g., by selecting the “Submit” button in graphical user interface 400), the user of the computing device (e.g., user computing device 140) may (e.g., by selecting the “Modify” button in graphical user interface 400) make any desired changes to the allocation information (e.g., changes to the payment options and/or amounts). In turn, fragmented payment computing platform 110 may cause the computing device (e.g., user computing device 140) to display and/or otherwise present one or more graphical user interfaces similar to graphical user interface 500, which is illustrated in FIG. 5. As shown in FIG. 5, graphical user interface 500 may include text and/or other information providing the user of the computing device (e.g., user computing device 140) a notification to enter reallocation information (e.g., modify the allocation information) (e.g., “Edit your payment details here. [Credit Card A . . . Amount 1 . . . ] [Debit Card B . . . Amount 4 . . . ] [Stored Value Card D . . . Amount 3 . . . ]”). For example, at 502, the user of the computing device (e.g., user computing device 140) may change a payment method (e.g., from [Credit Card C . . . ] as shown in graphical user interface 400, to [Stored Value Card D . . . ] as shown in graphical user interface 500). Additionally or alternatively, at 504, the user of the computing device (e.g., user computing device 140) may change a payment amount (e.g., from [Amount 2 . . . ] as shown in graphical user interface 400, to [Amount 4 . . . ] as shown in graphical user interface 500). It will be appreciated that other and/or different notifications may also be provided.

At step 210, fragmented payment computing platform 110 may modify the allocation information indicating the amount of funds to be transferred from each of the plurality of user accounts. In turn, at step 211, fragmented payment computing platform 110 may receive confirmation of the allocation information. For example, the user of the computing device (e.g., user computing device 140) may select the “Submit” button in graphical user interface 400 to confirm the allocation information (e.g., payment details of the transaction using the selected payment accounts).

At step 212, fragmented payment computing platform 110 may update machine learning models based on the allocations and/or reallocations. In this way, fragmented payment computing platform 110 may automatically allocate fragments based on a user's previous reallocations.

Referring to FIG. 2D, at step 213, fragmented payment computing platform 110 may store information associated with the fragmented transactions. For example, a fragmented payment transactions database (e.g., fragmented transactions database 112b) may be maintained that identifies a payment transaction with a plurality of card or account transactions. In this way, fragmented payment computing platform 110 may treat the payment transaction as a single transaction and associate the payment transaction with the fragmented transactions stored in the fragmented payment transactions database (e.g., fragmented transactions database 112b).

At step 214, fragmented payment computing platform 110 may perform authentication and authorization associated with the plurality of user accounts. For example, fragmented payment computing platform 110 may initiate a token exchange between card issuer banks and card networks for validating card data. In some examples, the token exchange may be and/or include a single or common one-time password (OTP) token generated for any number of cards or accounts associated with a fragmented transaction. In addition, fragmented payment computing platform 110 may send the generated OTP to a user (e.g., user of user computing device 140), such as by text or electronic mail message. The single OTP, provided by the user, may be validated by an authentication server which authorizes the transaction. In some embodiments, the plurality of user accounts may include third-party accounts at third-party institutions. For example, a financial institution may be allowed access the third-party accounts at third-party systems using the single (e.g., common) OTP generated for any number of cards or accounts.

At step 215, fragmented payment computing platform 110 may transfer funds to a recipient account in accordance with the allocation information (e.g., based on receiving confirmation of the allocation information at step 211). For instance, fragmented payment computing platform 110 may transfer funds to a merchant account (e.g., at merchant computing system 130). At step 216, fragmented payment computing platform 110 may generate and send, via the communication interface (e.g., communication interface 113), one or more notifications. For example, fragmented payment computing platform 110 may generate and send one or more notifications to user computing device 140 or other computing device indicating completed processing of the fragmented payment transaction.

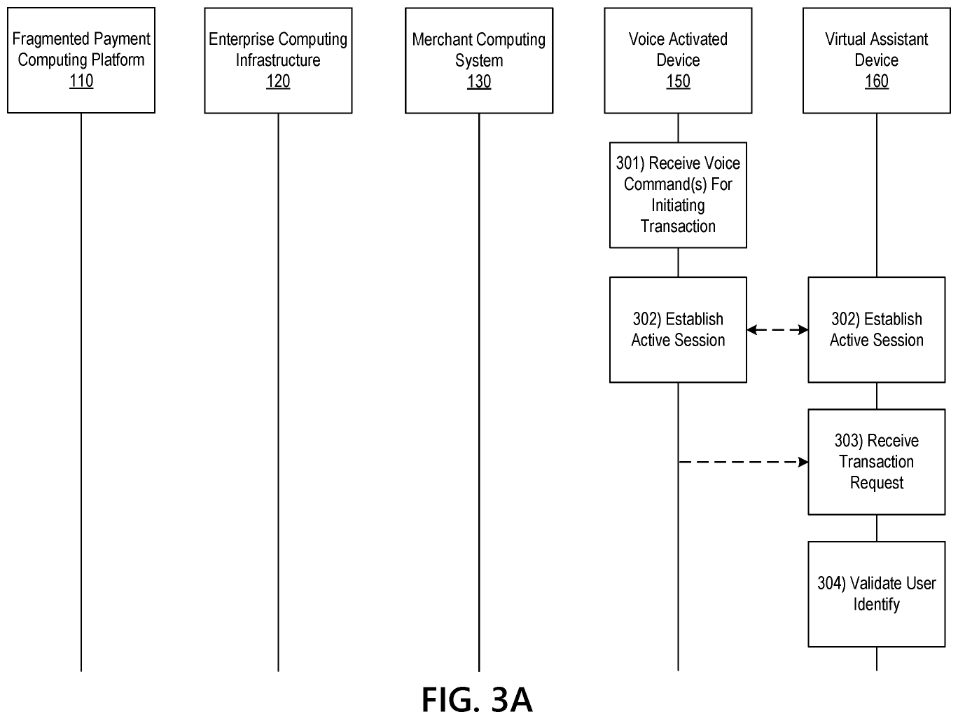

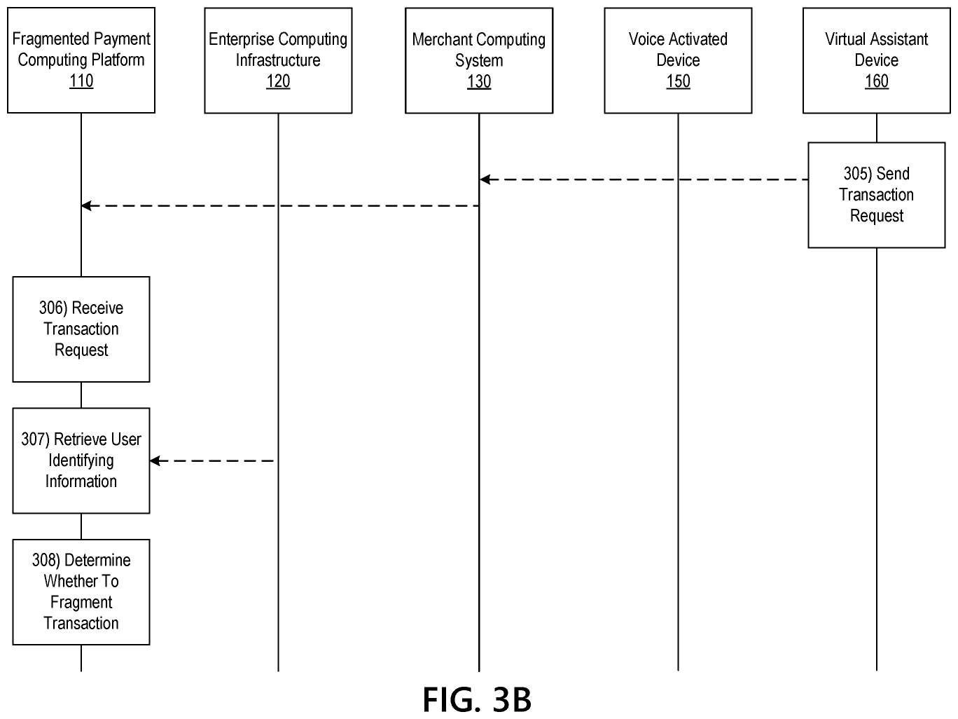

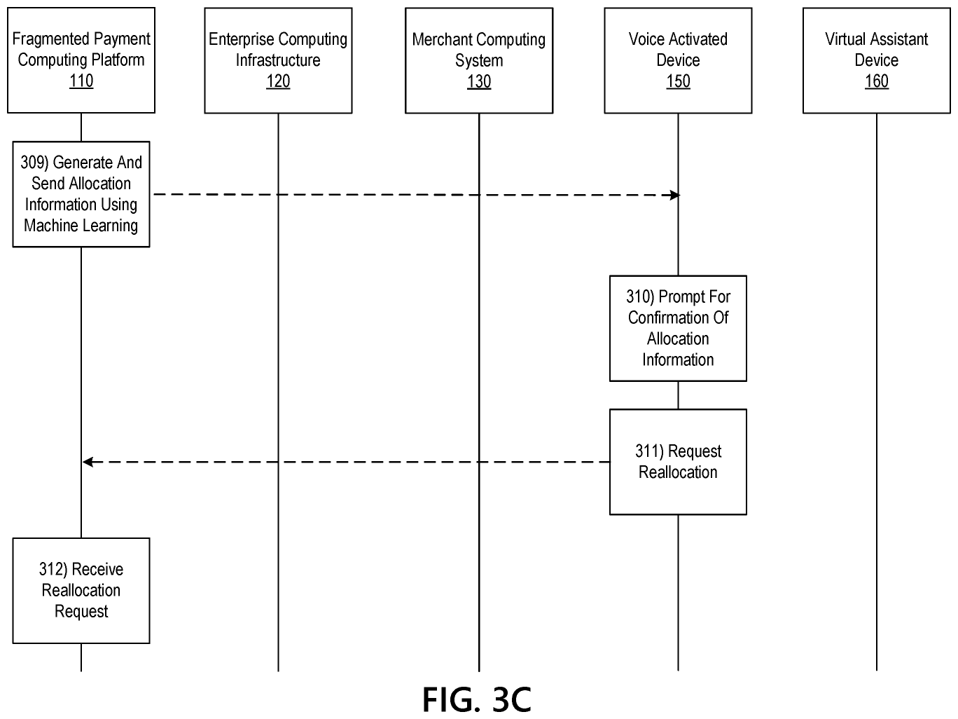

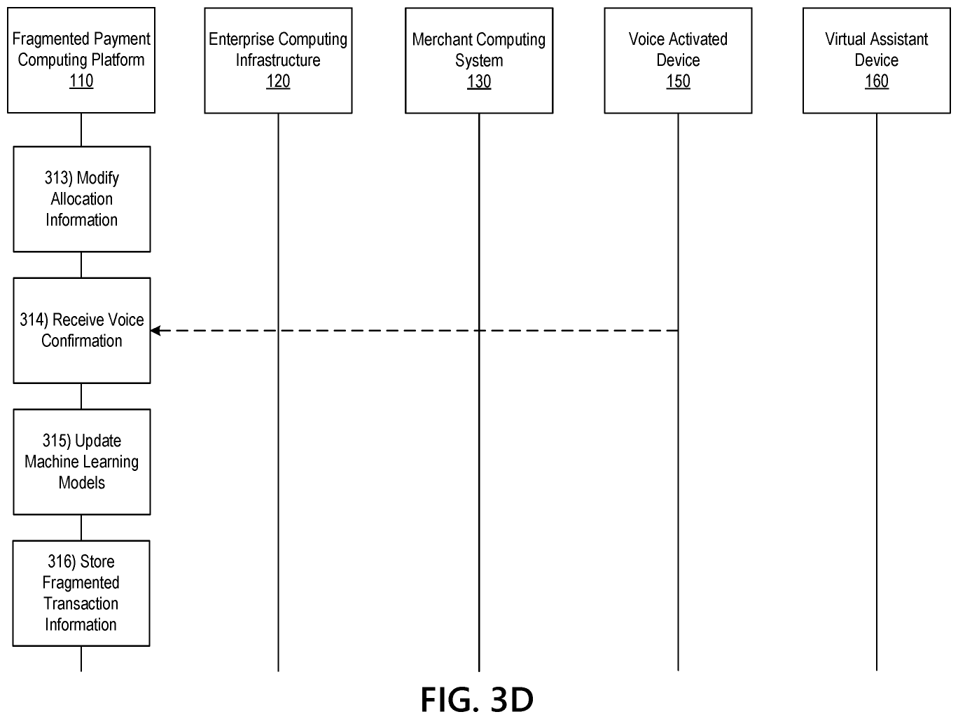

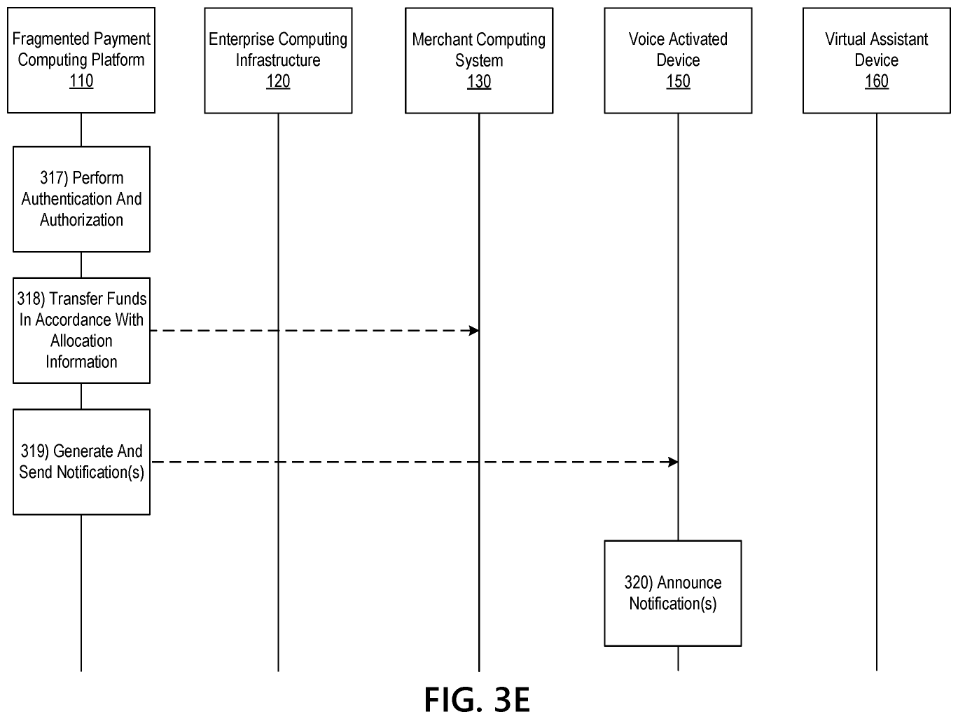

FIGS. 3A-3E depict another illustrative event sequence for fragmenting payment transactions in accordance with one or more example embodiments. For example, the example event sequence depicted in FIGS. 3A-3E illustrates a use case for fragmenting payment transactions involving transactions initiated through a voice activated device (e.g., via a smart speaker integrated with a virtual assistant device).

Referring to FIG. 3A, at step 301, a voice activated device (e.g., smart speaker) may receive one or more voice commands for initiating a transaction (e.g., a payment transaction). For example, a user of a voice activated device (e.g., voice activated device 150) may use voice shopping to place an order with a merchant (e.g., using their voice to make purchases).

At step 302, an active session may be established (e.g., handshaking) between the voice activated device (e.g., voice activated device 150) and the virtual assistant (e.g., virtual assistant device 160). At step 303, the voice activated device (e.g., voice activated device 150) may send the transaction request to the virtual assistant (e.g., virtual assistant device 160).

At step 304, the virtual assistant (e.g., virtual assistant device 160) may validate a user's identity (e.g., user of voice activated device 150). For example, fragmented payment computing platform 110 may cause the virtual assistant (e.g., virtual assistant device 160) to authenticate the user (e.g., user of voice activated device 150) based on user identification information shared by the voice activated device and authorize the payment transaction via voice input of the user. For instance, the virtual assistant (e.g., virtual assistant device 160) may validate the user's identity (e.g., user of voice activated device 150) using one or more of a voice ID, a device ID, device proximity, encrypted tokens, or other security feature establishing user identity.

Referring to FIG. 3B, at step 305, the virtual assistant (e.g., virtual assistant device 160) may send the transaction request to fragmented payment computing platform 110 (e.g., via the merchant computing system 130). In addition, the virtual assistant (e.g., virtual assistant device 160) may send user authentication information to fragmented payment computing platform 110. In turn, at step 306, fragmented payment computing platform 110 may receive, via the communication interface (e.g., communication interface 113), the request for the transaction (e.g., the payment transaction) initiated at the voice activated device (e.g., voice activated device 150) and the user authentication information.

At step 307, fragmented payment computing platform 110 retrieve user identifying information associated with fragmenting payment transactions. In some examples, fragmented payment computing platform 110 may retrieve one or more pre-established user preferences associated with fragmenting payment transactions. Such pre-established user preferences may be defined by the user of the voice activated device (e.g., voice activated device 150). For instance, a user may define a preference to use a particular account for high tendered amounts (e.g., above a threshold amount) and/or a preference to use a different particular account for low tendered amounts (e.g., below a threshold amount).

Additionally or alternatively, in retrieving user identifying information associated with fragmenting payment transactions at step 307, fragmented payment computing platform 110 may retrieve account information associated with a plurality of financial accounts of a user. For instance, fragmented payment computing platform 110 may retrieve account information associated with one or more credit card accounts, checking accounts, savings accounts, debit card accounts, stored value accounts, and/or the like, associated with the user of the virtual assistant device (e.g., virtual assistant device 160). In addition, fragmented payment computing platform 110 may retrieve an account balance or a credit limit for each of the plurality of financial accounts of the user of the virtual assistant device (e.g., virtual assistant device 160).

At step 308, fragmented payment computing platform 110 may determine whether to fragment (e.g., divide or split) the payment transaction between a plurality of user cards or accounts. The determination on whether to fragment the payment transaction may be made, for example, based on the user identifying information (e.g., retrieved at step 307). For instance, fragmented payment computing platform 110 may determine to fragment a transaction based on pre-established user preferences for fragmenting transactions and/or based on a need or requirement to access funds from more than one card or account to process a transaction.

Referring to FIG. 3C, at step 309, based on determining to fragment the payment transaction, fragmented payment computing platform 110 may generate and send allocation information to the voice activated device (e.g., voice activated device 150). For example, the allocation information may indicate an amount of funds to be transferred from each of the plurality of user accounts. In some examples, fragmented payment computing platform 110 may generate the allocation information indicating an amount of funds to be transferred from each of the plurality of user accounts based on historical allocation information (e.g., using machine learning or other artificial intelligence). For instance, fragmented payment computing platform 110 may, based on a transaction history of a user, suggest or prefill certain transaction details (e.g., allocation information) for the user, and the user may modify those details based on their needs, as discussed in greater detail below.

At step 310, fragmented payment computing platform 110 may cause the voice activated device (e.g., voice activated device 150) to prompt the user of the voice activated device (e.g., voice activated device 150) to confirm the allocation information (e.g., generated at step 309). For example, fragmented payment computing platform 110 may cause the voice activated device (e.g., voice activated device 150) to speak or announce information. For instance, the voice activated device (e.g., voice activated device 150) may speak or announce information notifying the user of the voice activated device (e.g., voice activated device 150) of allocation information and providing an opportunity to perform reallocation (e.g., modify the allocation information) (e.g., “Please confirm your payment details. [Amount 1] will be charged to [Credit Card A], [Amount 2] will be charged to [Debit Card B], and [Amount 3] will be charged to [Credit Card C]”). It will be appreciated that other and/or different notifications may also be provided.

In some embodiments, at step 311, prior to confirming the allocation information, the user of the voice activated device (e.g., voice activated device 150) may send, via the communication interface (e.g., communication interface 113), a reallocation request (e.g., request to modify the allocation information). At step 312, fragmented payment computing platform 110 may receive, via the communication interface (e.g., communication interface 113), from the user of the voice activated device (e.g., voice activated device 150), voice input specifying one or more modifications to the allocation information. For example, prior to confirming the allocation information, the user of the allocation information (e.g., from voice activated device 150) may speak a command (e.g., “Modify it.”) to make any desired changes to the allocation information (e.g., changes to the payment options and/or amounts). For example, the user of the voice activated device (e.g., voice activated device 150) may speak the reallocation information (e.g., “Please charge [Amount 1] to [Credit Card A]; [Amount 2] to [Stored Value Card D]; and [Amount 4] to [Credit Card C]”). It will be appreciated that other and/or different commands may also be provided.

Referring to FIG. 3D, at step 313, fragmented payment computing platform 110 may modify the allocation information indicating the amount of funds to be transferred from each of the plurality of user accounts. In turn, at step 314, fragmented payment computing platform 110 may receive voice confirmation of the allocation information (e.g., from voice activated device 150). For example, the user of the voice activated device (e.g., voice activated device 150) may speak a command (e.g., “Confirm it.”) to confirm the allocation information (e.g., payment details of the transaction using the selected payment accounts).

At step 315, fragmented payment computing platform 110 may update machine learning models based on the allocations and/or reallocations. In this way, fragmented payment computing platform 110 may automatically allocate fragments based on a user's previous reallocations.

At step 316, fragmented payment computing platform 110 may store information associated with the fragmented transactions. For example, a fragmented payment transactions database (e.g., fragmented transactions database 112b) may be maintained that identifies a payment transaction with a plurality of card or account transactions. In this way, fragmented payment computing platform 110 may treat the payment transaction as a single transaction and associate the payment transaction with the fragmented transactions stored in the fragmented payment transactions database (e.g., fragmented transactions database 112b).

Referring to FIG. 3E, at step 317, fragmented payment computing platform 110 may perform authentication and authorization associated with the plurality of user accounts. For example, fragmented payment computing platform 110 may initiate a token exchange between card issuer banks and card networks for validating card data. In some examples, the token exchange may be and/or include a single or common one-time password (OTP) token generated for any number of cards or accounts associated with a fragmented transaction. In addition, fragmented payment computing platform 110 may send the generated OTP to a user (e.g., user of voice activated device 150), such as by text or electronic mail message. The single OTP, provided by the user, may be validated by an authentication server which authorizes the transaction. A fragmented payment transactions database (e.g., fragmented transactions database 112b) may be maintained that identifies a payment transaction with a plurality of card or account transactions. In some embodiments, the plurality of user accounts may include third-party accounts at third-party institutions. For example, a financial institution may be allowed access the third-party accounts at third-party systems using the single (e.g., common) OTP generated for any number of cards or accounts.

At step 318, fragmented payment computing platform 110 may transfer funds to a recipient account in accordance with the allocation information (e.g., based on receiving confirmation of the allocation information at step 314). For instance, fragmented payment computing platform 110 may transfer funds to a merchant account (e.g., at merchant computing system 130). At step 319, fragmented payment computing platform 110 may generate and send, via the communication interface (e.g., communication interface 113), one or more notifications. For example, fragmented payment computing platform 110 may generate and send one or more notifications to voice activated device 150 or other computing device indicating completed processing of the fragmented payment transaction. At step 320, voice activated device 150 may announce completed processing of the fragmented payment transaction.

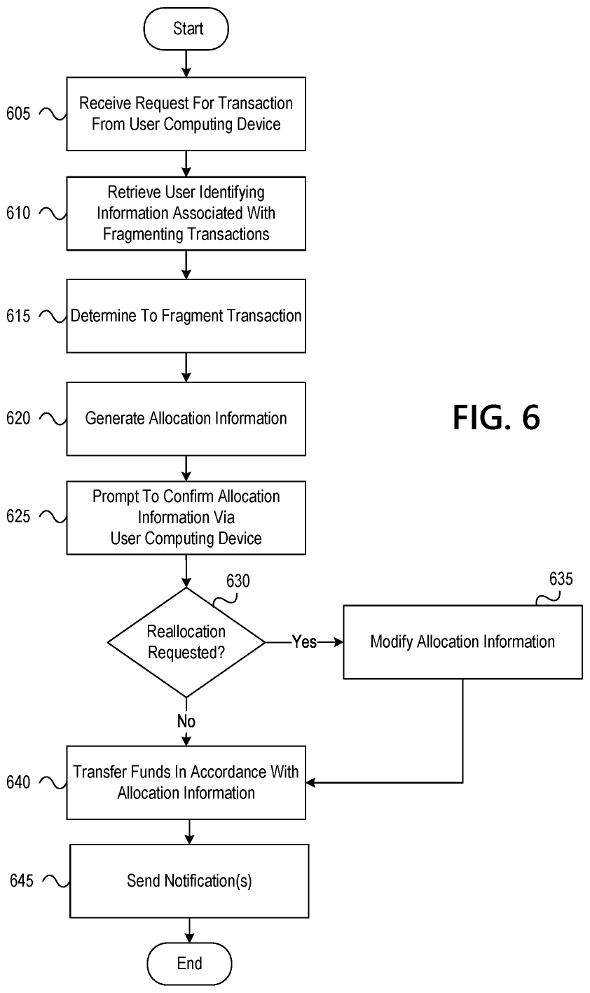

FIG. 6 depicts an illustrative method for fragmenting payment transactions in accordance with one or more example embodiments. Referring to FIG. 6, at step 605, a computing platform having at least one processor, a communication interface, and memory may receive, from a computing device, a request for a payment transaction. At step 610, the computing platform may retrieve user identifying information associated with fragmenting payment transactions. At step 615, the computing platform may, based on the user identifying information, determine to fragment the payment transaction between a plurality of user accounts. At step 620, the computing platform may, based on determining to fragment the payment transaction, generate, using a machine learning algorithm, allocation information indicating an amount of funds to be transferred from each of the plurality of user accounts. At step 625, the computing platform may, cause the computing device to prompt a user of the computing device to confirm the allocation information. At step 630, the computing platform may receive, from the user of the computing device, input specifying one or more modifications to the allocation information. At 635, the computing platform may modify the allocation information indicating the amount of funds to be transferred from each of the plurality of user accounts. At 640, the computing platform may transfer funds to a recipient account in accordance with the allocation information. At step 645, the computing platform may send a notification indicating completed processing of the fragmented payment transaction.

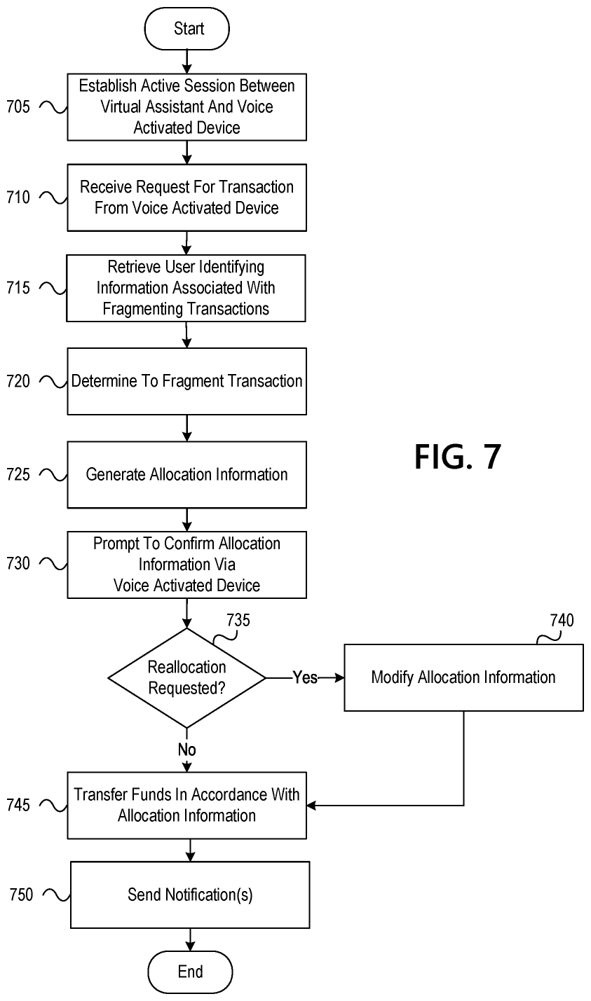

FIG. 7 depicts an illustrative method for fragmenting payment transactions in accordance with one or more example embodiments. Referring to FIG. 7, at step 705, a virtual assistant may establish an active session with a voice activated device. At step 710, a computing platform having at least one processor, a communication interface, and memory may receive, from the virtual assistant, a request initiated at the voice activated device for a payment transaction. At step 715, the computing platform may retrieve user identifying information associated with fragmenting payment transactions. At step 720, the computing platform may, based on the user identifying information, determine to fragment the payment transaction between a plurality of user accounts. At step 725, the computing platform may generate, using a machine learning algorithm, allocation information indicating an amount of funds to be transferred from each of the plurality of user accounts. At step 730, the computing platform may cause the voice activated device to prompt the user to confirm the allocation information. At step 735, the computing platform may receive, from the voice activated device, input specifying one or more modifications to the allocation information. At step 740, the computing platform may modify the allocation information indicating the amount of funds to be transferred from each of the plurality of user accounts. At step 745, based on receiving voice confirmation of the allocation information, transfer funds to a recipient account in accordance with the allocation information. At step 750, the computing platform may send a notification indicating completed processing of the fragmented payment transaction.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive, via the communication interface, from a computing device, a request for a payment transaction;
retrieve user identifying information associated with fragmenting payment transactions;
based on the user identifying information, determine whether to fragment the payment transaction between a plurality of user accounts;
based on determining to fragment the payment transaction, generate, using a machine learning algorithm, allocation information indicating an amount of funds to be transferred from each of the plurality of user accounts;
cause the computing device to prompt a user of the computing device to confirm the allocation information;
transfer funds to a recipient account in accordance with the allocation information; and
send, via the communication interface, a notification indicating completed processing of the fragmented payment transaction.

2. The computing platform of claim 1, wherein the memory stores additional computer-readable instructions that, when executed by the at least one processor, cause the computing platform to:
prior to transferring funds to the recipient account in accordance with the allocation information, receive, via the communication interface, from the user of the computing device, input specifying one or more modifications to the allocation information; and
modify the allocation information indicating the amount of funds to be transferred from each of the plurality of user accounts.

3. The computing platform of claim 1, wherein retrieving user identifying information associated with fragmenting payment transactions comprises retrieving one or more pre-established user preferences associated with fragmenting payment transactions.

4. The computing platform of claim 3, wherein the one or more pre-established user preferences are defined by the user.

5. The computing platform of claim 1, wherein retrieving user identifying information associated with fragmenting payment transactions comprises retrieving account information associated with a plurality of financial accounts of a user.

6. The computing platform of claim 5, wherein retrieving the account information associated with the plurality of financial accounts of the user comprises retrieving account information associated with one or more of: a credit card account, a checking account, a savings account, a debit card account, or a stored value account.

7. The computing platform of claim 5, wherein retrieving the account information associated with the plurality of financial accounts of the user comprises retrieving an account balance or a credit limit for each of the plurality of financial accounts.

8. The computing platform of claim 1, wherein generating the allocation information comprises generating the allocation information indicating an amount of funds to be transferred from each of the plurality of user accounts based on historical allocation information.

9. The computing platform of claim 1, wherein receiving the request for the payment transaction comprises receiving, from a merchant system, the request initiated on a mobile device executing an application associated with a merchant.

10. The computing platform of claim 1, wherein fragmenting the payment transaction between the plurality of user accounts comprises authenticating with third-party accounts of the plurality of user accounts using a single one-time password (OTP) token.

11. A method, comprising:
at a computing platform comprising at least one processor, a communication interface, and memory:
receiving, by the at least one processor, via the communication interface, from a computing device, a request for a payment transaction;
retrieving, by the at least one processor, user identifying information associated with fragmenting payment transactions;
based on the user identifying information, determining, by the at least one processor, whether to fragment the payment transaction between a plurality of user accounts;
based on determining to fragment the payment transaction, generating, by the at least one processor, using a machine learning algorithm, allocation information indicating an amount of funds to be transferred from each of the plurality of user accounts;
causing, by the at least one processor, the computing device to prompt a user of the computing device to confirm the allocation information;
transferring, by the at least one processor, funds to a recipient account in accordance with the allocation information; and
sending, by the at least one processor, via the communication interface, a notification indicating completed processing of the fragmented payment transaction.

12. The method of claim 11, wherein further comprising:
prior to transferring funds to the recipient account in accordance with the allocation information, receiving, by the at least one processor, via the communication interface, input from the user of the computing device specifying one or more modifications to the allocation information; and
modifying, by the at least one processor, the allocation information indicating the amount of funds to be transferred from each of the plurality of user accounts.

13. The method of claim 11, wherein retrieving user identifying information associated with fragmenting payment transactions comprises retrieving one or more pre-established user preferences associated with fragmenting payment transactions.

14. The method of claim 13, wherein the one or more pre-established user preferences are defined by the user.

15. The method of claim 11, wherein retrieving user identifying information associated with fragmenting payment transactions comprises retrieving account information associated with a plurality of financial accounts of a user.

16. The method of claim 15, wherein retrieving the account information associated with the plurality of financial accounts of the user comprises retrieving account information associated with one or more of: a credit card account, a checking account, a savings account, a debit card account, or a stored value account.

17. The method of claim 15, wherein retrieving the account information associated with the plurality of financial accounts of the user comprises retrieving an account balance or a credit limit for each of the plurality of financial accounts.

18. The method of claim 11, wherein generating the allocation information comprises generating the allocation information indicating an amount of funds to be transferred from each of the plurality of user accounts based on historical allocation information.

19. The method of claim 11, wherein receiving the request for the payment transaction comprises receiving, from a merchant system, the request initiated on a mobile device executing an application associated with a merchant.

20. One or more non-transitory computer-readable media storing instructions that, when executed by a computing platform comprising at least one processor, a communication interface, and memory, cause the computing platform to:
receive, via the communication interface, from a computing device, a request for a payment transaction;
retrieve user identifying information associated with fragmenting payment transactions;
based on the user identifying information, determine whether to fragment the payment transaction between a plurality of user accounts;
based on determining to fragment the payment transaction, generate, using a machine learning algorithm, allocation information indicating an amount of funds to be transferred from each of the plurality of user accounts;
cause the computing device to prompt a user of the computing device to confirm the allocation information;
transfer funds to a recipient account in accordance with the allocation information; and
send, via the communication interface, a notification indicating completed processing of the fragmented payment transaction.
